(19) United States
(12) Patent Application Publication
(10) Pub. No.: US 2002/0146536 A1
(43) Pub. Date: Oct. 10, 2002

(54) Orthopaedic support

(75) Inventor: Maurice R. Bard, Markham (CA)

Correspondence Address: Dennison Associates, Suite 301, 133 Richmond Street West, Toronto, ON, M5H 2L7, CA

(73) Assignee: GSW Inc.

(21) Appl. No.: 09/828,196

(22) Filed: Apr. 9, 2001

(51) Int. Cl. B32B 3/10

(52) U.S. Cl. 428/138; 428/167

(57) ABSTRACT

An orthopaedic support comprises a substrate having a series of channels in one surface thereof with a series of vent holes in the channels to promote heat dissipation through the substrate. The channels provide cooling of the skin in contact with the orthopaedic support without rendering the substrate prone to damage. Vent holes are located in the channels to provide venting through the orthopaedic support and the dissipation of heat.

### FIELD OF THE INVENTION

The present invention relates to orthopaedic supports and in particular, relates to a composite substrate for orthopaedic supports having improved breathability.

### BACKGROUND OF THE INVENTION

Neoprene layers have been used for orthopaedic supports as they have the ability to stretch and are initially relatively comfortable. Typically, the neoprene layer has a cloth fibre layer on the surface thereof to improve the comfort. Unfortunately, neoprene or other closed cell foam layers are not breathable and tend to retain heat about the body part. Initial heat retention can be advantageous as it warms the particular body part, however, over an extended period of time, it leads to discomfort, possible skin rashes, and is not desirable. These poor operating characteristics often contribute to the orthopaedic support not being used.

It has been known to use a closed cell foam structure with a breathable fabric either side to improve the characteristics of the composite material. Unfortunately, the closed cell foam acts as an excellent thermal insulation and excess heat and moisture typically occurs.

U.S. Pat. No. 5,620,771 discloses a specialized orthopaedic substrate layer which has a series of pin holes with each pin hole having almost a pressure release valve associated therewith for venting. This structure also tends to maintain moisture and maintain heat.

The present invention seeks to overcome the shortcomings described above.

### SUMMARY OF THE INVENTION

An orthopaedic support according to the present invention comprises a composite substrate for fasting about a body part with the composite substrate comprising a closed cell foam layer with a series of interconnecting channels in one side thereof. A series of holes through the closed cell foam layer connect with these channels and provide improved venting and air circulation. The composite substrate includes a breathable layer covering the one side of the closed cell foam layer and this breathable layer cooperates with the channels and a series of holes to provide air circulation through the composite substrate and through the channels.

It has been found that the composite substrate as described above provides improved air circulation through the substrate and also movement of the body part of the orthopaedic support will also expand or compress the composite substrate and provide a pumping action further improving the circulation.

According to a further aspect of the invention, the composite substrate includes a breathable fabric on an exterior surface of the closed cell foam layer opposite the breathable layer.

According to yet a further aspect of the invention, the orthopaedic support is reversible to alter the heat retention characteristic of the orthopaedic support.

In yet a further aspect of the invention, the channels include longitudinal channels, lateral channels and diagonal channels.

In yet a further aspect of the invention, the longitudinal channels, lateral channels and diagonal channels intercept with some of the series of holes through the closed cell foam layer.

In yet a further aspect of the invention, the closed cell foam layer is made of neoprene.

In yet a further aspect of the invention, the channels occupy less than 25 per cent of the one side of the closed cell foam layer.

### BRIEF DESCRIPTION OF THE DRAWINGS

Preferred embodiments of the invention are shown in the drawings, wherein:

FIG. 1 is a partial perspective view showing a neck orthopaedic support applied to a user;

FIG. 2 is a partial exploded view showing the different layers of the composite substrate;

FIG. 3 is a sectional view through the composite substrate showing the interconnection of the channels and holes;

FIG. 4 is a partial perspective view of the closed cell foam layer with various channels and holes provided on one side of this layer;

FIG. 5 is a bottom view of a modified substrate;

FIG. 6 is a partial sectional view along line 66 of FIG. 5;

FIG. 7 is a partial perspective view of the diagonal channels and the modified substrate; and

FIG. 8 is a section view along line 8—8 of FIG. 7.

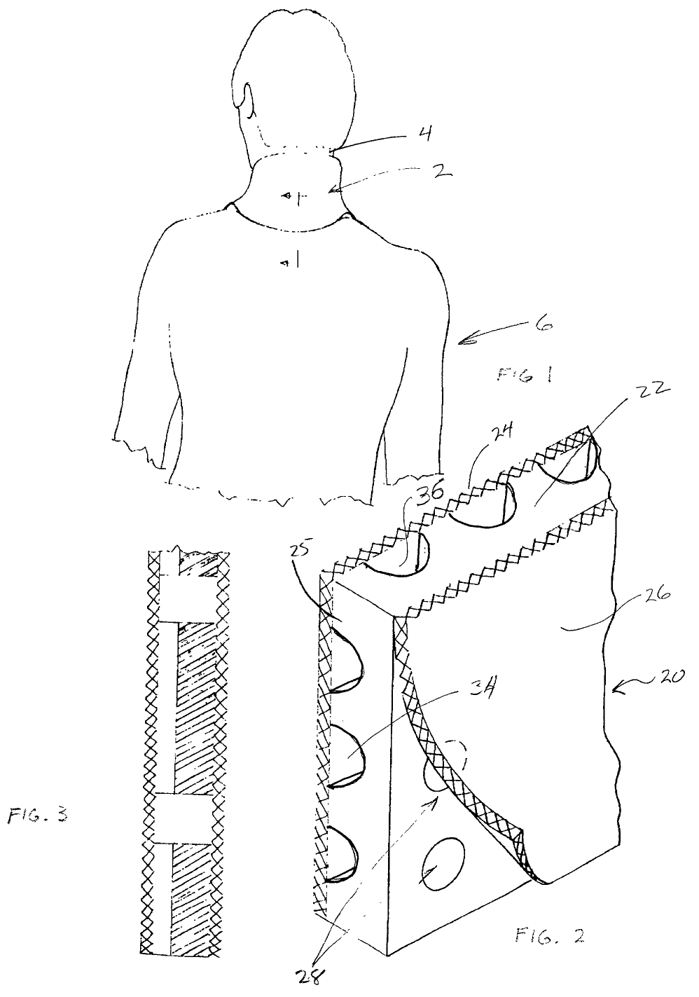

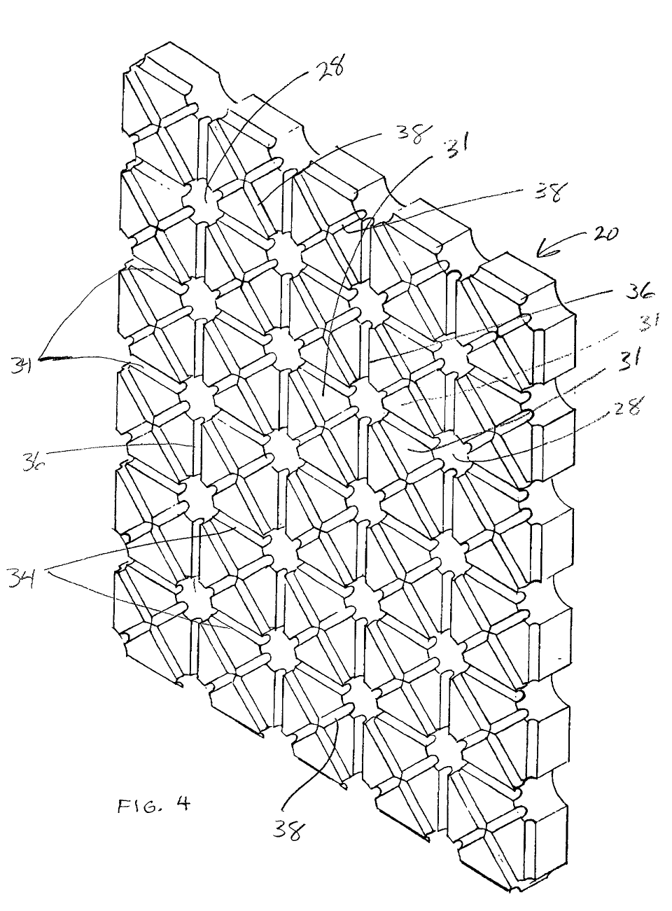

### DETAILED DESCRIPTION OF THE PREFERRED EMBODIMENTS

The orthopaedic support 2 is shown applied about the neck 4 of the user 6. As can be appreciated, this orthopaedic support is suitable for a host of different applications from knee supports, to elbow supports, to ankle supports, to back supports, etc.

The orthopaedic support is preferrably made of a composite substrate 20 comprising a closed cell foam layer 22, an exterior fabric breathable layer 26, and an interior breathable fabric layer 24. The closed cell foam layer 22 has a series of holes 28 through the layer to allow venting to the exterior of the substrate. The interior surface 25 of the foam substrate 22 has a series of longitudinal channels 34, a series of lateral channels 36, and a series of diagonal channels 38. These channels all open onto the holes 28 and provide venting of the interior surface of the orthopaedic support through the holes 28 to the exterior. The breathable fabric layer 24 provides a more comfortable layer to be applied against the skin of the user and also assists in allowing venting to one of the channels and eventually through the holes 28.

Although closed cell neoprene is preferred, other materials and open foams can be used, and provide the required support.

As clearly shown in FIG. 4, the interior surface of the foam layer which is preferrably of neoprene, has been broken into small island portions 31 which provide a contact surface for adhering to the breathable layer 24. With these small regions, the channels surround these regions and promote air circulation and the distribution and venting of heat and moisture. Any compressive movement of the orthopaedic support caused by the user bending that particular body part will promote increased air circulation through the orthopaedic support.

For example, if the substrate is compressed, air will be exhausted through the holes 28 and when the compressive force is removed, the substrate will return to its original condition and draw new air into the channels through the holes 28. In addition, the natural tendency of the orthopaedic support will provide some air circulation even without this pumping action.

The island portions 31 provide a support network which contacts the skin of the user. Some compression will occur but the channels remain functional and remove heat acting as a cool boundary to the islands.

With this arrangement, the desirable comfort and heat retaining capability of the neoprene is used to allow initial warm up and maintaining a comfortable heat level with respect to the particular body part while allowing ventilation and moisture removal.

A further desirable feature of the present invention is the reversibility of the orthopaedic support such that the exterior fabric layer 26 may be broad in contact with the user's skin. In this case, increased heat retention is achieved as there are no channels provided on that side of the closed cell foam layer. Some breathing is still provided through the holes 28 but the orthopaedic support will tend to maintain more heat. This may be desirable for an initial warm up where the user desires the particular muscle or body part to be kept quite warm and once the user has effectively warmed up, the orthopaedic support can be reversed if less heat retention is desired.

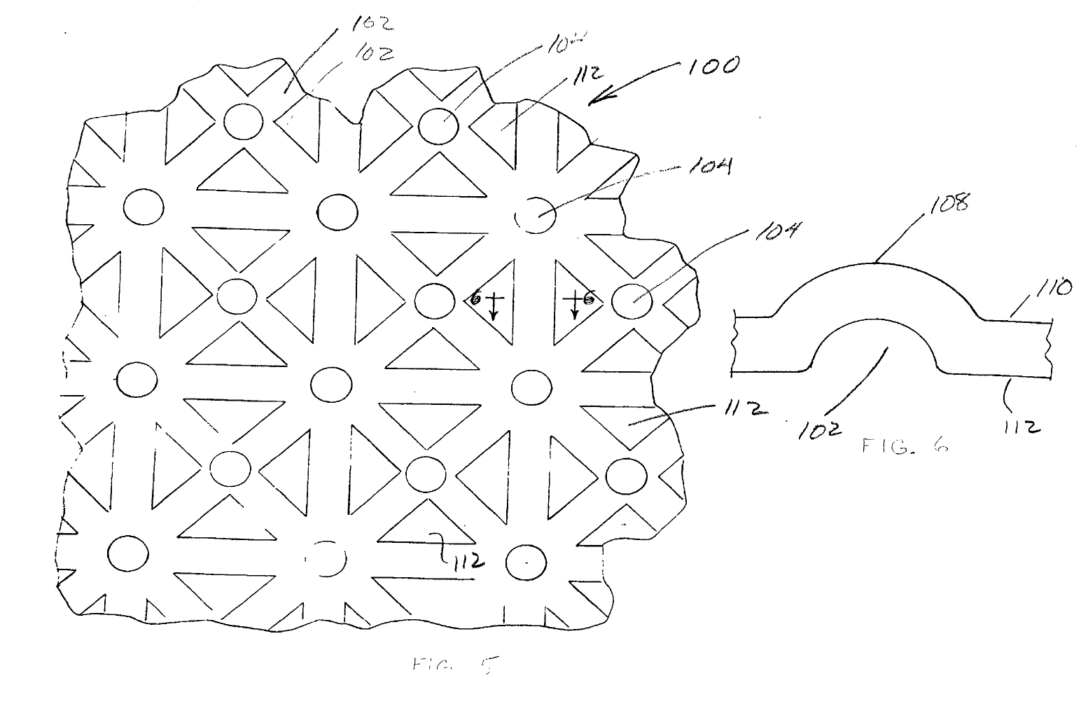

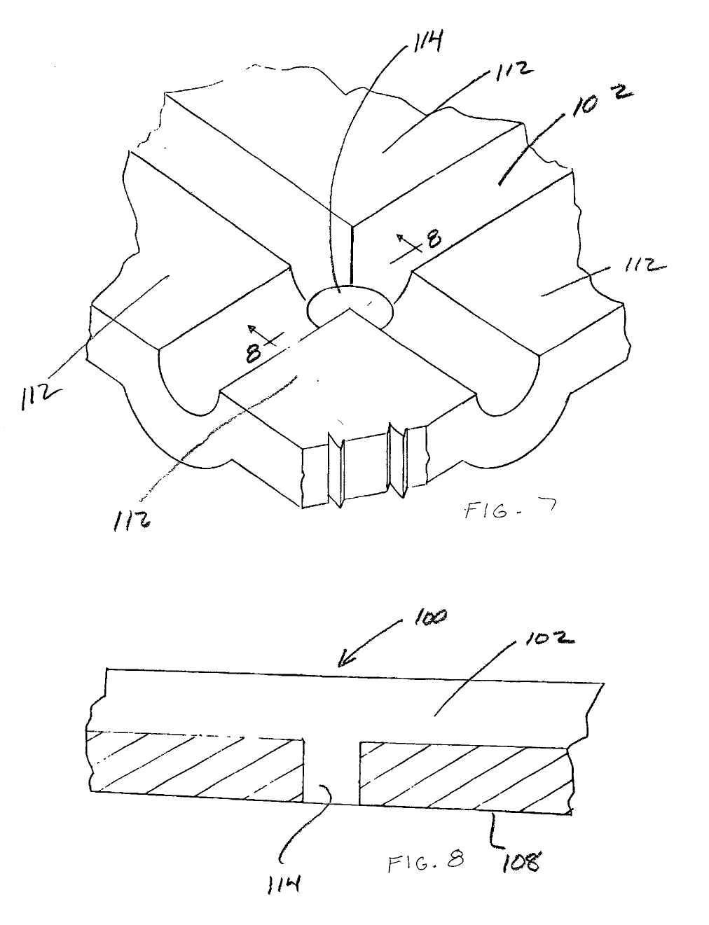

A modified orthopaedic support substrate is shown in FIG. 5 through FIG. 8. In this modified substrate 100, a 6 cm by 6 cm square grid, together with intersecting diagonals is used. The channels 102 are located on the grid and on the diagonals. Breathing ports 104 are at each intersection. The channels are preferrably, approximately, 5 mm wide and the holes are of a similar diameter. The fabric material is displaced with the foam substrate and the rear surface of the channels 108 are displaced and protrude on the exterior surface 110 of the substrate (see FIG. 6). Triangular support islands 112 are formed and these islands preferrably represent about 60 per cent of the area of the support layer which engages the skin of the user. Some compression occurs but the channels generally remain open for venting to a hole and the outside air. As shown, even the centre of an island is not far from the cooling of a channel to provide dissipation about each island.

The substrate is about 4 mm thick and the channels are displaced approximately this thickness.

The grid size is preferably increased or decreased to adjust the ratio of support area to cooling area. As the grid size is increased, the support area increases. Support area is preferably as large as possible while still providing effective cooling. The preferred range of support area is between 50 per cent to 75 per cent of the substrate area. The main design criteria is effective cooling which is achieved through the channels and holes. Holes alone reduce structural strength and render the support more prone to damage. Channels and holes provide an effective method for providing structural integrity and effective cooling. Other arrangements, other than grids, can also be used that allow effective venting and cooling beneath the orthopaedic support.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. An orthopaedic support comprising a composite substrate for fastening about a body part, said composite substrate comprising a closed cell foam layer with a series of interconnecting channels in one side thereof and a series of holes through said closed cell foam layer which also connect with said channels, said composite substrate including a breathable layer covering said one side of said closed cell foam layer which cooperates with said channels and said series of holes to provide air circulation through said composite substrate and through said channels.

2. An orthopaedic support as claimed in claim 1 wherein said composite substrate includes a breathable fabric on an exterior surface of said closed cell foam layer opposite said breathable layer.

3. An orthopaedic support as claimed in claim 2 wherein said orthopaedic support is reversible to alter heat retention characteristics of the orthopaedic support.

4. An orthopaedic support as claimed in claim 1 wherein said channels include longitudinal channels, lateral channels and diagonal channels.

5. An orthopaedic support as claimed in claim 4 wherein all channels intersect with intersect with some of the holes of the series of holes.

6. An orthopaedic support as claimed in claim 1 wherein said closed cell foam layer is made of a neoprene.

7. An orthopaedic support as claimed in claim 1 wherein said channels occupy less than 50 per cent of said one side of said closed cell foam layer.

8. An orthopaedic support comprising a composite substrate for fastening about a body part, said composite substrate comprising a foam substrate with a series of interconnecting channels in one side thereof and a series of holes through said foam substrate which also connect with said channels, said channels cooperate with said series of holes to provide heat dissipation through said channels and venting through said holes.

9. An orthopaedic support as claimed in claim 8 wherein said composite substrate includes a breathable fabric on an exterior surface of said foam substrate and a breathable layer on an interior surface.

10. An orthopaedic support as claimed in claim 9 wherein said orthopaedic support is reversible to alter heat retention characteristics of the orthopaedic support.

11. An orthopaedic support as claimed in claim 8 wherein said channels include longitudinal channels, lateral channels and diagonal channels.

12. An orthopaedic support as claimed in claim 11 wherein a hole of said series of holes is associated with the intersection of channels.

13. An orthopaedic support as claimed in claim 1 wherein said closed cell foam substrate is made of a neoprene.

14. An orthopaedic support as claimed in claim 1 wherein said channels occupy less than 40 percent of said one side of said closed cell foam layer.
